(19) United States
(12) Patent Application Publication
(10) Pub. No.: US 2012/0127368 A1
(43) Pub. Date: May 24, 2012

(54) ANTI-BLUR APPARATUS FOR E.G. BACKLIGHT OF LIQUID CRYSTAL DISPLAY

(75) Inventors: Martin Jacobus Johan Jak, Eindhoven (NL); Gerben Johan Hekstra, Eindhoven (NL); Michiel Adriaanszoon Klompenhouwer, Eindhoven (NL)

(73) Assignee: KONINKLIJKE PHILIPS ELECTRONICS N.V., EINDHOVEN (NL)

(21) Appl. No.: 13/255,186

(22) PCT Filed: Mar. 2, 2010
(86) PCT No.: PCT/IB10/50887

§ 371 Date: Sep. 7, 2011

(30) Foreign Application Priority Data
Mar. 9, 2009 (EP) 09154621.8

(51) Int. Cl. H04N 5/14

(52) U.S. Cl. 348/576; 348/E05.062

(57) ABSTRACT

A display control apparatus comprises a video source(105) which provides a video signal comprising frames. The video source (105) is coupled to a compensation processor (107) which filters at least part of a first frame to provide a compensation for perceived motion blur. A display output (109) feeds the compensated video signal to a display (103) which presents the frame. A controller (111) is arranged to control the display (103) such that it radiates light in a sequence of light pulses for each frame where the sequence of light pulses comprising at least some light pulses having different durations. A motion blur processor (113) determines a suitable compensation filter for the perceived motion blur compensation as one that corresponds to an inverse filter of the sequence of light pulses. The use of pulsed light radiation modifies the hold effect filtering such that it can be better and more easily compensated by pre-filtering.

### FIELD OF THE INVENTION

The invention relates to a display control apparatus and a method therefor, and in particular, but not exclusively, to perceived motion blur compensation for hold type displays.

### BACKGROUND OF THE INVENTION

In recent years the use of Cathode Ray Tube technology for display systems has been largely superseded by use of flat display technologies, such as Liquid Crystal Display (LCD) panels. Many of the most popular or promising display technologies, such as active matrix LCD or active matrix OLED (Organic Light Emitting Diode) displays are so-called hold-type displays. In contrast to for example a CRT, where images are presented in a very short impulse followed by period of no light emission, the images on hold-type displays are not flashed but are continuously presented for the entire duration of a frame. This avoids flicker but is also known to cause perceived motion blur.

The motion of objects on a display links the time response of the display to the spatial domain. For a moving object, the perceived image is blurred along the direction of motion since the human eye tracks the average motion of the object. However, for a hold-type display the image is updated only once a frame-time and thus results in a sequential presentation of static images corresponding to snap shots of the movement. Thus, the presented image can be considered to judder around the average track. This juddering is generally not visible to an observer but tends to be perceived as a blurring effect. The longer the hold-time of the display and the larger the motion-speed, the more pronounced the perceived blur.

In the past, several solutions have been proposed to address motion blur for LCD displays. For example, it has been proposed to reduce the hold-time of the display by flashing or scanning the backlight, or by introducing black frames. However, whereas the motion blur effect is proportional to the hold time, so is the light intensity and thus brightness that can be provided by the image. Therefore, for such systems there is an inherent trade-off between motion sharpness (which requires a short duty cycle for the backlight) and brightness (which requires a long duty cycle). In most practical systems, this trade-off does not allow a display that provides both sufficiently attractive motion sharpness and brightness.

It has also been proposed to reduce the hold-time by increasing the frame rate. However this only solves the motion blur when additional motion compensated frames are generated and inserted and does not have any effect if the frames are simply repeated. Thus, it will require new content to be provided or complex processing to be applied to modify existing content. Also, the frame rate will typically be substantially limited by the practical limitations of the display and/or by the number of frames that can be generated with motion compensated up-conversion. In practice, frame rate enhancement is typically only feasible for a frame-rate doubling (e.g. 60 to 120 Hz conversion). This results in a halving of the original hold-time which albeit an improvement tends to be insufficient and still result in clearly perceptible motion blur.

Another solution to avoid motion blur is so-called “Motion Compensated Inverse Filtering” (MCIF). This method relies on first detecting the moving parts in an image, then determining how much they would be blurred if nothing were done, and then to apply an inverse filter such that after blurring the correct image is shown.

However, although promising results can be obtained using MCIF, it is difficult to effectively remove sufficient blur without creating artefacts and degrading quality. Specifically, the effect of the hold time is such that it is not feasible to realize an accurate inverse filter to compensate for the hold effect. Accordingly, the filtering will tend to result in only a partial mitigation of the blurring and to the introduction of other artefacts.

Hence, an improved approach for using hold-type displays would be advantageous and in particular an approach allowing increased flexibility, facilitated operation or manufacturing, reduced perceived motion blur, reduced quality degradation and artefacts; increased brightness, reduced complexity and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a display control apparatus, comprising: means for providing a video signal comprising frames; means for presenting the video signal on a display ; control means for controlling the display to radiate light in a sequence of light pulses for each frame, the sequence of light pulses comprising light pulses having different durations; determining means for determining a first filter corresponding to an inverse filter of the sequence of light pulses; and filter means for filtering at least part of a first frame in response to the first filter.

The invention may provide improved perceived video quality and/or facilitated operation and/or implementation. In particular, in many scenarios a reduced perceived motion blur can be achieved while maintaining low complexity. The filtering by the first filter may specifically provide a compensation pre-filtering that at least partially compensates for the perceived motion blur effect caused by the hold effect of the hold type display.

The approach may specifically allow that the hold effect of the display is modified to correspond to a filtering effect that can be mitigated better and/or more easily by a pre-filtering. In particular, a compensation pre-filter providing a better approximation to the inverse of the hold effect filtering can be achieved. Thus, the system may allow that a more practical compensation pre-filter can be determined and realized. Thus, an improved pre-filtering can be achieved while maintaining low complexity when determining and realizing this filter. In particular, the presence and extent of notches in the filtering resulting from the hold effect can be substantially reduced (and specifically zero's in the frequency response can be avoided) thereby allowing a more accurate and/or realizable inverse filter to be used as a pre-compensation.

In accordance with an optional feature of the invention, the determining means is arranged to determine a spatial filter corresponding to a filtering effect of the sequence of light pulses applied to a moving object in the first frame; and determine the first filter as corresponding to an inverse of the spatial filter; and the filtering means is arranged to apply the first filter to the moving object in the first frame.

This may provide improved and/or facilitated operation in many scenarios. In particular, it may allow the compensation pre-filtering by the first filter to be adapted to the specific effect of the hold effect on the individual moving object. Thus, the compensation pre-filtering may be adapted to the specific motion characteristics of the individual moving object.

The determining means may be arranged to determine suitable first filters for a plurality of moving video objects and the filtering means may be arranged to apply the appropriate first filter to each of the plurality of moving video objects.

In accordance with an optional feature of the invention, the determining means is arranged to determine the spatial filter as having a spatial impulse response corresponding to a motion of the moving object during the light pulses of the sequence of light impulses.

This may provide improved and/or facilitated operation in many scenarios. In particular, it may allow the first filter to be adapted to the specific impact of the hold effect on the individual moving object. Thus, the compensation pre-filtering may be adapted to the specific motion characteristics of the individual moving object.

The display control apparatus may specifically be arranged to identify a moving object in a sequence of frames; determine a motion characteristic for the moving object; determine a spatial impulse response for the moving object in response to the time impulse response of the sequence of light pulses and the motion characteristic; to determine the first filter for the moving object to correspond to an inverse spatial filter of the spatial impulse response for the moving object; and to apply the first filter for the moving object to the moving object.

Determining the first filter may comprise determining an amplitude frequency response for the first filter to correspond to a reciprocal of an amplitude frequency response corresponding to the spatial impulse response.

In accordance with an optional feature of the invention, the determining means is arranged to determine an amplitude frequency response of the spatial filter and to determine an amplitude frequency response of the first filter in response to a reciprocal of the amplitude frequency response of the spatial filter.

This may provide improved and/or facilitated operation in many scenarios.

In accordance with an optional feature of the invention, the sequence of light pulses comprises at least four light pulses having different durations.

This may provide improved performance and may in particular result in a motion blurring effect arising from the hold effect that can be mitigated more easily or better by a compensation pre-filtering. In many embodiments, improved performance can be achieved for an increasing number of light pulses having different durations. The difference between the durations of any two light pulses may be 50% or more of the duration of the shortest light pulse.

In some embodiments, particularly advantageous performance can be achieved for a sequence of light pulses comprising at least seven or ten light pulses with different durations.

In accordance with an optional feature of the invention, durations of at least two light pulses of the sequence of light pulses differ by at least 10% of the frame rate.

This may provide improved performance and may in particular result in a motion blurring effect of the hold effect that can be more easily or better mitigated by a compensating pre-filtering. In some embodiments, the difference in duration between a shortest and longest light pulse may be higher than 40% of the frame time.

In some embodiments, the difference in duration between a shortest and longest light pulse in the sequence of light pulses may be higher than 25% of the duration of the longest light pulse.

The duration between light pulses may also vary between at least two sets of light pulses. In particular, a shortest duration may vary relative to a longest duration by at least 10% of the frame rate or 10% of the duration of the longest light pulse.

In accordance with an optional feature of the invention, the sequence of light pulses is such that a total duration of light radiation during a frame duration is between 20% and 80% of the frame duration.

This may allow improved performance in many scenarios and may in particular allow an improved trade-off between the motion blur quality and the brightness that can be provided by the display.

In accordance with an optional feature of the invention, a frequency response of an impulse response corresponding to the sequence of light pulses has a dynamic range of less than 10 dB in at least 95% of a frequency range from 0 Hz to 100 Hz.

This may provide improved performance in many scenarios and may in particular result in a motion blurring effect of the hold effect that can be more easily or better mitigated by a compensation pre-filtering. In particular, it may allow for closer approximation to the inverse filter to be used.

In some embodiments, the sequence of light pulses is such that frequency responses of at least two light pulses of the sequence of light pulses do not have coinciding notches. Specifically, at least two of the light pulses are such that they do not have coinciding zeros in the frequency domain.

In accordance with an optional feature of the invention, the control means is arranged to control a backlight for the display in response to the sequence of light pulses.

This may provide improved performance in many embodiments. The invention may in particular provide reduced perceived motion blur for backlight displays, such as active matrix LCD displays.

In accordance with an optional feature of the invention, a repeated pattern of light pulses is synchronized with a line time for the display.

This may provide improved and/or facilitated operation. In particular, it may allow a facilitated determination of a suitable filter for different movement characteristics. In many scenarios it may result in a simplified control while reducing a dependency on the position of moving objects in the frame.

In accordance with an optional feature of the invention, a repeated pattern of light pulses is synchronized with a frame time for the display.

This may provide improved and/or facilitated operation. In particular, it may allow a facilitated determination of a suitable filter and in many scenarios allow the same compensation in different frames.

In accordance with an optional feature of the invention, the control means is arranged to modify the sequence of light pulses in response to motion characteristics of a moving video object in the frames.

This may provide improved and/or facilitated operation. In particular, it may allow improved adaptation of perceived motion blur compensation to the current conditions and characteristics.

In accordance with an optional feature of the invention, the control means is arranged to modify the sequence of light pulses in response to an image characteristic of a frame.

This may provide improved and/or facilitated operation. In particular, it may allow improved adaptation of perceived motion blur compensation to the current conditions and characteristics.

In accordance with an optional feature of the invention, the control means is arranged to uniformly apply the sequence of light pulses to a full display area of the display.

This may facilitate operation in many embodiments.

According to an aspect of the invention there is provided a method of controlling a display, the method comprising: providing a video signal comprising frames; presenting the video signal on a display; controlling the hold-type display to radiate light in a sequence of light pulses for each frame, the sequence of light impulses comprising light pulses having different durations; determining a first filter corresponding to an inverse filter of the sequence of light impulses; and filtering at least part of a first frame in response to the first filter.

These and other aspects, features and advantages of the invention will be apparent from and elucidated with reference to the embodiment(s) described hereinafter.

Embodiments of the invention will be described, by way of example only, with reference to the drawings, in which

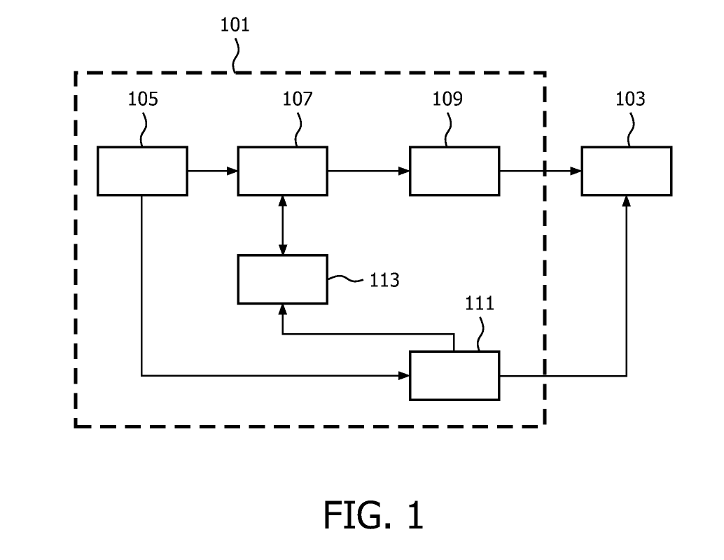

FIG. 1 illustrates an example of a display control apparatus 101 in accordance with some embodiments of the invention;

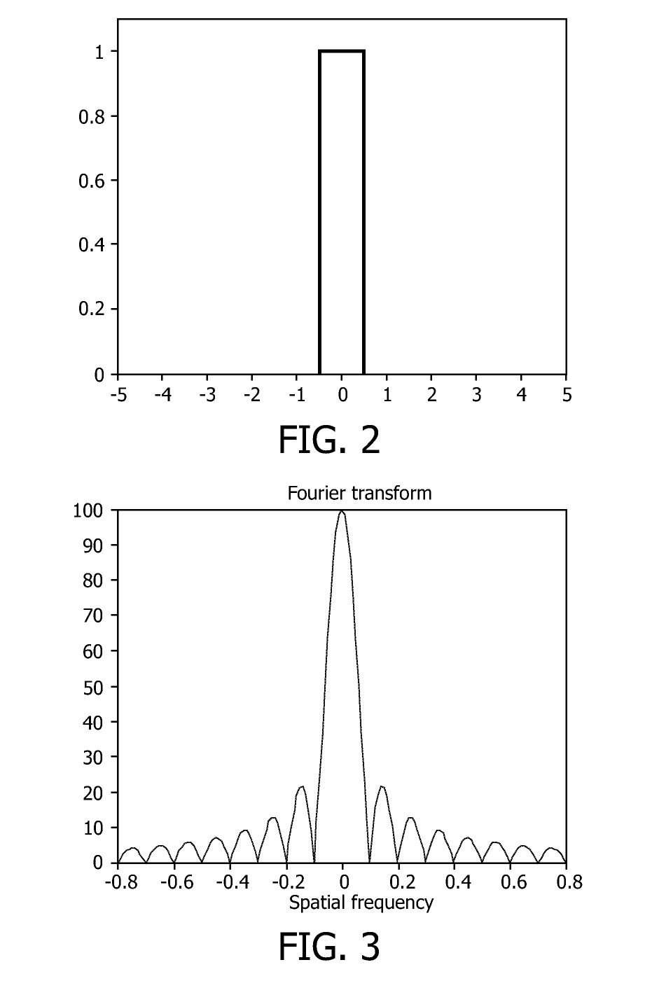

FIG. 2 illustrates an example of an impulse response for a spatial filter corresponding to a hold effect filtering of a hold type display;

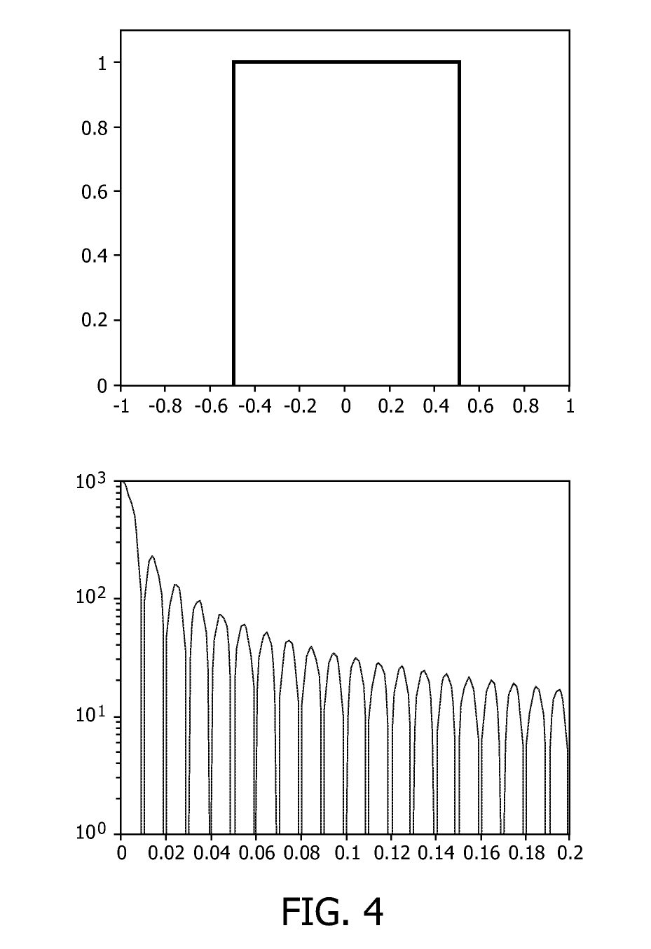

FIG. 3 illustrates an example of an amplitude frequency response for a spatial filter corresponding to a hold effect filtering of a hold type display;

FIG. 4 illustrates an example of an impulse response and a frequency for a spatial filter corresponding to a hold effect filtering of a hold type display; and

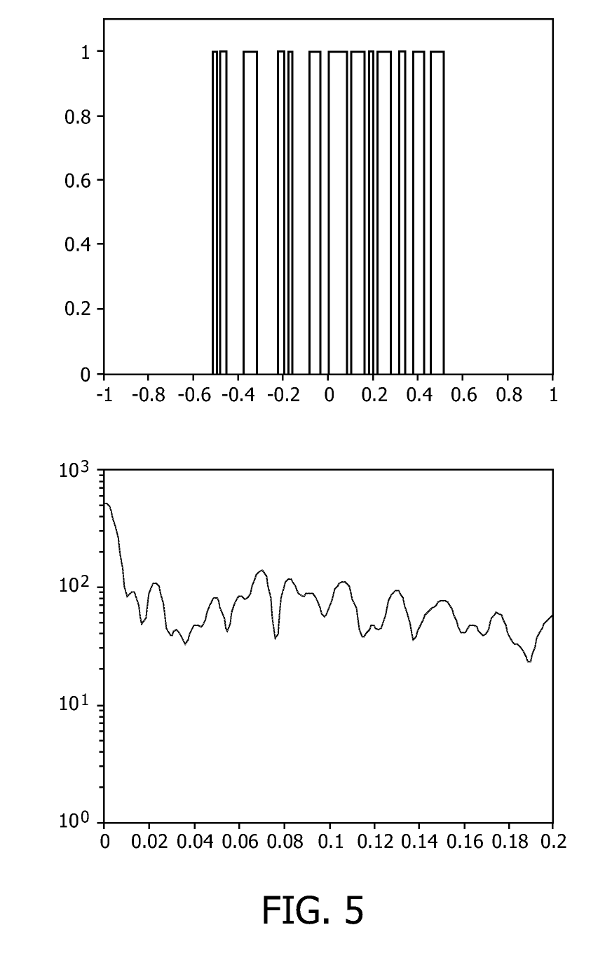

FIG. 5 illustrates an example of an impulse response and a frequency for a spatial filter corresponding to a hold effect filtering of a hold type display in accordance with some embodiments of the invention.

### BRIEF DESCRIPTION OF THE EMBODIMENTS

The following description focuses on embodiments of the invention applicable to a backlight LCD display. However, it will be appreciated that the invention is not limited to this application but may be applied to many systems using hold-type displays such as for example OLED displays.

FIG. 1 illustrates an example of a display control apparatus 101 in accordance with some embodiments of the invention. The display apparatus 101 drives a display panel 103 which in the example is a backlit active matrix LCD display. In the system of FIG. 1, the display control apparatus 101 controls both the active matrix LCD (i.e. the individual brightness of each individual pixel) as well as the backlight for the display panel.

The display panel 103 is a hold-type panel and thus the image is not flashed in a short burst but rather is continuously presented during the frame time when the display is radiating light. Thus, for a constant backlight the same image may be presented throughout the duration of each individual frame.

A problem in conventional hold type displays is that the extended duration of each static frame results in a perceived motion blur for moving images. The human eye tracks the average motion of an object. However, in a conventional hold type display, the image is constant throughout the frame duration and the presentation of a static and sharp moving object for the entire frame duration results on a series of snapshots of the average motion. Therefore the object seems to judder around its average track. This is perceived by a viewer as motion blur.

In some systems, it has been proposed to pre-filter moving objects of an image to compensate for this hold effect. Specifically, an inverse filtering of the filtering imposed by the hold effect can be introduced to offset this effect. This may essentially lead to the moving object being smeared in the image by an amount that corresponds to the specific movement of the object and the specific characteristics of the hold effect of the display.

Specifically, a hold time effect may be represented by a correlation of the moving object by a spatial filter that has an impulse response corresponding to the hold time applied to the specific motion. Thus, for a constant motion, assuming sufficiently fast response of the LCD display, the hold effect may be represented by a convolution of the moving object by a spatial filter having a rectangular shape and a width determined as the product of the frame time (i.e. the hold time) and the speed of movement. Thus, the hold effect may be represented by a spatial filtering of the moving object and a spatial filter having a spatial impulse response such as that illustrated in FIG. 2.

A convolution in the spatial domain corresponds to a multiplication in the frequency domain and as multiplication is substantially less resource demanding than convolution, it is typically desirable to apply a compensation filtering to the moving object by multiplying the frequency representation of this by a frequency response of an inverse filter of the hold-effect filtering (i.e. the cascading of the pre-filter and the hold effect filtering will ideally result in a flat and constant phase frequency response).

However, the frequency response of a rectangular impulse response is a sinc(x)=sin(x)/x function as is illustrated in FIG. 3. However, such a frequency response is characterized by a very large dynamic range with very deep notches (i.e. strong attenuations at very specific spatial frequencies). In particular, a sinc(x) function comprises a number of zero's.

In order to fully compensate for this effect, it is accordingly necessary to provide an inverse filter but as is clear from FIG. 3 this is not possible as it would require infinite gain at some spatial frequencies. More generally, in a practical implementation, a reasonably close approximation to the inverse filter of the hold-effect filtering is extremely difficult and complex to implement, and accordingly suboptimal filters are typically used. However, this results in suboptimal motion blur mitigation and introduces artefacts resulting in a degraded image quality.

However, in the system of FIG. 1 the hold effect is modified such that an improved compensation filtering can be applied thereby resulting in reduced motion blur and improved image quality while maintaining a low complexity.

Specifically, instead of presenting a constant image during the frame time, the light radiation of the display is pulsed in accordance with a sequence of light pulses wherein at least some of the light pulses have different durations. Thus, the constant light radiation of a conventional hold type display during a frame time is in the system of FIG. 1 modulated by a sequence of shorter pulses with different durations. For example, rather than providing a constant backlight during a frame period, the backlight may be flashed with a rapid pseudo-random series of short and even shorter pulses. This will result in a modification of the time response of the display and thus of the hold effect upon moving objects. Specifically, a hold effect filtering that is much more harmonious may be achieved and specifically a frequency response of the hold effect filtering which is substantially flatter with a reduced dynamic range can be achieved.

FIG. 4 illustrates an example of an impulse and frequency response corresponding to a conventional hold-type display wherein the image is presented throughout the frame duration and FIG. 5 illustrates an example of an impulse and frequency response of a system wherein the backlight is pulsed in accordance with a sequence of pulses. As is very clearly demonstrated, a much flatter frequency response can be achieved and specifically the deep attenuations can be avoided. In particular, the zeros of the frequency response of FIG. 4 are completely avoided in the frequency response of FIG. 5.

As a consequence, the inverse filter of the hold effect filtering is substantially easier to determine and specifically is substantially easier to realize. Thus, a much better approximation of the compensation filter to the ideal inverse filter of the hold effect filtering can be determined and applied to the moving object resulting in reduced perceived motion blur, reduced artefacts and thus improved image quality.

The display control apparatus 101 comprises a video source 105 which provides a video signal. The video signal may be received from any internal or external source such as e.g. from a DVD player, a television receiver, a hard disc etc. The video signal comprises a sequence of frames or images that may include both moving and stationary image objects.

The video source 101 is coupled to a compensation processor 107 which is arranged to apply a compensation filter to the moving objects of the video signal. Specifically, for each identified moving object in each frame, a compensation filter may be determined and applied to the moving object. As the appropriate compensation filter typically depends on the motion characteristics of the individual moving object and thus the compensation filter applied to different moving objects may typically be different.

The compensated video frames are fed to a display output processor 109 which is further coupled to the display panel 103 via a suitable link. The display output processor 109 feeds the image data to the display panel 103. For example, the display output processor 109 may generate and provide individual pixel values controlling the light output from individual pixels. E.g. the display output processor 109 may provide RGB or YUV pixel values.

It will be appreciated that the display control apparatus 101 may be external or separate from the display panel 103 or may be integrated with the display panel 103. For example, the display control apparatus 101 and the display panel 103 may be part of a television or a monitor. As another example, the display control apparatus 101 may be part of a separate source coupled to the display panel 103 through a suitable video connection standard, such as a DisplayPort™, HDMI™ or DVI™ interface.

The display control apparatus 101 further comprises a backlight controller 111 which in the system of FIG. 1 is coupled to the display panel 103 and which controls the backlight of this. The backlight controller 111 is specifically capable of switching the backlight on and off during each frame duration. The backlight controller 111 controls the backlight such that the display panel 103 radiates light in a sequence of light pulses for each frame where the sequence of light pulses comprise at least two light pulses with different durations. Thus, the backlight controller 111 switches the backlight on and off several times during each frame period such that the backlight is pulsed with pulses having varying durations. The backlight controller 111 may for example control the backlight to be pulsed by a pseudo random sequence such as that illustrated in FIG. 5.

The display control apparatus 101 also comprises a motion blur processor 113 which is coupled to the backlight controller 111 and the compensation processor 107. The motion blur processor 113 is arranged to determine a compensation filter that corresponds to the inverse filter of the sequence of light pulses. Specifically, for each motion object the motion blur processor 113 determines an (approximate) estimated inverse filter to the hold effect filtering which results from the pulsing of the backlight. This compensation filter is then fed to the compensation processor 107 which proceeds to apply the filter to the moving object prior to the frame being presented on the display 103.

In more detail, the compensation processor 107 is arranged to identify and track moving image objects in the video signal. It will be appreciated that many different algorithms for this are known to the skilled person and that any suitable algorithm may be used without detracting from the invention. Thus, when a new frame is received to be processed, the compensation processor 107 first identifies any moving objects to which motion blur compensation should be applied. The motion characteristics of these image objects are fed to the motion blur processor 113 which also receives information of the sequence of light pulses. In some embodiments, the characteristics of the sequence of light pulses may be modified and accordingly the information may be updated in accordance with this modification. In other embodiments, a predetermined fixed sequence of light pulses may be used and the motion blur processor 113 may simply use this predetermined sequence.

The motion blur processor 113 then proceeds to determine a spatial filter for each moving object where the spatial filter corresponds to the filtering effect of applying the sequence of time pulses to the moving object. Specifically, a spatial filter having a spatial impulse response corresponding to the time domain response of the sequence of pulses modified in response to the motion characteristics is determined. This spatial filter corresponding to the filtering effect of the sequence of light pulses on a moving object may e.g. simply be determined by multiplying the time domain response by the speed of the moving object (assuming a constant speed of the moving object during the frame period). For example, the contribution of one pulse having a width of, say, 1 ms for a moving object having a speed of, say, 40 pixels per 20 msec frame can be determined as 2 pixels. The spatial impulse response is determined by combining the contribution from all the pulses (and intervals) of the pulse sequence. Thus, the resulting spatial impulse response has an identical shape in the spatial domain as the sequence of light pulses has in the time domain.

The motion blur processor 113 may then determine a frequency response corresponding to the spatial impulse response. As the spatial impulse response corresponds to the pulse sequence, the frequency response may have a relatively low dynamic range and may be free from deep notches or zeroes. For example, a frequency response such as that of FIG. 5 can be achieved.

The motion blur processor 113 can then proceed to determine the compensation filter for the specific moving object as one approximating a filter having an amplitude frequency response that is the reciprocal (i.e. substantially proportional to 1/H(f) where H(f) is the spatial filter amplitude response) of the amplitude frequency response of the spatial filter. The phase response may be determined is the inverse of the phase response for the spatial filter. It will be appreciated that different techniques for approximating a given filter characteristic in view of a given filter constraint (such as a complexity constraint) will be known to the skilled person and need not be described further herein.

The resulting filter is then fed to the compensation processor 107 where it is applied to the moving object for which it is determined. The application may typically be performed in the frequency domain. For example, the moving object may be isolated and converted to the frequency domain where it is multiplied by the determined compensation filter. The result may then be converted back to the spatial domain and added to the residual image remaining after the initial extraction of the moving object.

It will be appreciated that the motion blur processor 113 may not proceed to calculate the inverse filter for each moving object and frame. E.g. if the same pulse sequence is used continuously, the corresponding frequency response for the compensation filter for a given nominal speed may be stored. This predetermined filter may then be used directly by the compensation processor 107 or may be directly scaled (along the frequency axis) for other speeds. In other embodiments, a plurality of compensation filter characteristics for different speeds (and/or directions) may be stored in a look-up table. The motion blur processor 113 may then simply retrieve the filter characteristic that most closely matches the detected motion speed for the image object.

Thus, the system of FIG. 1 uses a sequence of pulses with different directions to generate a hold effect that is much more manageable and specifically is much easier to compensate for by a compensation pre-filtering. Especially, the irregular pulsing results in a filtering effect for which it is much easier to realize a more accurate inverse filter.

It will be appreciated that the characteristics of the sequence of light pulses may depend on the preferences and requirements for the specific application.

In many embodiments, it is desirable to use a relatively large number of pulses with different durations as this will tend to result in a reduced dynamic range and flatter frequency response. Particularly, it has been found that in many embodiments, the use of four or more light pulses with different durations within each frame tends to provide advantageous performance. Indeed, this tends to often provide a sufficiently flat response for which a sufficiently close approximation of the inverse filter can be realized. Typically, the frequency response and thus compensation filtering is increased for an increasing number of different pulses. Accordingly, in some embodiments, particularly advantageous performance may be achieved for 7, 12 or more different light pulses for each frame.

As an increasing number of pulses with different durations require more transitions between the backlight being on and off, the requirements for the speed of the display backlight will increase for increasing number of pulses. In order to provide for a fast switching, the display panel 103 may in many embodiments use fast switching light sources, such as Light Emitting Diodes (LEDs). In many embodiments, it is preferable to maintain the number of light pulses per frame to less than 15, 20 or 25 pulses.

Also, the variation of the duration of at least two different light pulses may advantageously in many embodiments differ by at least 10% of the frame rate. This may in many embodiments provide a hold effect filtering that is suitable for being mitigated by a compensation pre-filter. Indeed, in some embodiments at least two different light pulses may advantageously differ by at least 40% of the frame rate. Also, in many embodiments, the difference between at least some of the pulse durations may be at least 50% of the duration of the shortest pulse or e.g. 25% of the longest pulse. In many scenarios, it may be advantageous to have a relatively large number of different pulse durations and in some embodiments the pulse sequence may include at least 4, 7 10 or more different pulse durations.

Specifically, the resulting frequency response of the hold effect filtering corresponds to a summation of the phase adjusted frequency response of each individual pulse (where the phase adjustment is a linear phase variation corresponding to the relative delay of each pulse). Accordingly, a plurality of varying pulse durations will tend to have an averaging effect (as it is likely that zeros/notches/attenuations of the different frequencies do not coincide). In some embodiments, the pulse durations may be determined semi-randomly for example by using a pseudo random number generator. However, in other embodiments the pulse durations may be selected to provide a suitable frequency response. Similarly, the relative delay between pulses may be selected such that the corresponding frequency domain phase offset results in a desired combination of the individual frequency response.

As an example, the durations of at least some of the individual pulses may be such that their ratio is not an integer number. Specifically, two durations may specifically be selected such that the longer duration is not an integer of the shorter duration. As the zeros in the frequency domain representation of a rectangular pulse of duration T occur at multiples of 1/T, this may ensure that the zeros of the sinc(x) frequency response of the two pulses do not coincide. Thus, the pulse durations may be selected to avoid coinciding notches or zeros in the frequency domain. It should be noted that this can be ensured simply by ensuring that the frequency representation of the individual pulses do not have coinciding zeroes as the scaling in response to the speed of the moving object is the same for different pulses and speeds.

Thus, the sequence of light pulses may specifically be selected such that the resulting frequency response of the hold effect is relatively flat. This may specifically be achieved by controlling the frequency response of the impulse response that corresponds to the sequence of light pulses to have a restricted dynamic range within an operational frequency range. For many typical video applications, particularly advantageous performance can be achieved by selecting the sequence of light pulses such that frequency response of the sequence of light pulses (e.g. represented as the relative intensity as a function of time) has a dynamic range of less than 10 dB in at least 95% of a frequency range from 0 Hz to 100 Hz.

In many applications the total duration of light radiation during a frame is between 20% and 80% of the total frame duration. Thus, the sequence of pulses may be such that the backlight is on between 20% and 80% of the time. This may in most applications allow very efficient motion blur mitigation while at the same time providing a relatively high achievable brightness level. Indeed, in many embodiments, the combined duty cycle is advantageously between 40% and 70%

In the specific example of FIG. 1, the backlight is switched completely on an off thereby facilitating the switching. For example, the backlight controller 111 may simply control a single switching element in the power supply to the backlight. However, it will be appreciated that in other embodiments, the sequence of light pulse may also include light pulses of different intensities.

In some embodiments the sequence of pulses is repeated for each frame. Specifically, the pulsing of the backlight may be such that a repeated pattern of light pulses is synchronized with the frame time for the display. Thus, the repeated pattern has a duration corresponding to the frame time and starts at the same location for each frame. This allows the display control apparatus 101 to apply the same motion compensation to each frame thereby facilitating operation.

Furthermore, in many embodiments, the sequence of light pulses is uniformly applied to the full display area of the display panel 103. Thus, the entire light radiation from the display panel 103 is switched off and on simultaneously. For example, this allows a facilitated operation as a single switch element is sufficient to control the application of the pulse sequence to the display. E.g. a simple switch element for switching the backlight on and off can be used.

However, in many displays, the update of the individual pixels in the image is not simultaneous for the whole image. Rather, the updating of the pixel values for a new frame/image is typically performed on a line by line basis e.g. starting at the top and sequentially moving down one line at a time. Thus, the frame update is applied sequentially on a line by line basis. This scrolling update is typically relatively slow and updating the entire display often takes up most of the duration of a frame.

However, in a system wherein the backlight is pulsed uniformly, this results in the synchronization between the actual updating of a pixel for a new frame and the timing of the pulse sequence being dependent on the location of the pixel. Thus, the time alignment between the pulse sequence and the frame update is offset differently depending on the (typically vertical) position of the individual pixel. As this varying time offset equates to a varying linear phase variation in the frequency domain, the resulting frequency response of the hold effect filtering accordingly depends on the location in the image. Accordingly, the appropriate motion blur compensation filter depends not only on the speed but also on the location of the moving object to which it is applied.

In some embodiments, this may be addressed by determining the compensation filter for a moving object in response to the position of the object. For example, in some embodiments, a range of compensation filters may be stored for different positions and the motion blur processor 113 may retrieve the specific filter corresponding to the specific location of the moving object to which it is applied. This may complicate the required processing but may allow a facilitated backlight driving as this can be uniform for the display.

However, in other embodiments, the application of the sequence of light pulses may be adjusted in response to a display location. Specifically, the backlight controller 111 may be arranged to introduce a varying relative delay to the sequence of light impulses for different frame positions. The varying relative delay may be dependent on the frame/display position location. The varying relative delay may specifically be such that the sequence of light pulses at a given position is synchronized to a pixel frame update timing for that position.

Specifically, in a display which is sequentially addressed (updated) from top to bottom, the backlight may not pulse the entire display simultaneously but rather sequentially scroll the entire display from top to bottom in synch with the addressing (updating) of the display. Thus, a pulsed scanning backlight may be applied. This may ensure that the resulting hold effect filtering and hence the compensation filter is independent of the position within the frame.

As another example, the backlight controller 111 may use a repeated pattern of light pulses that are synchronized with a line time for the display when applying a uniform backlight control. Thus, the pulse sequence may repeat a pattern every line-time instead of every frame time. This will ensure that the same synchronization exists between the pattern and the pixel update for all positions of the display. Thus, the approach may obviate the need for scanning but will require faster switching of the backlight in order to make the sequence long enough to have the desired effect on the frequency response.

In some embodiments, the pulse sequence may be fixed. However, in other embodiments, the sequence of light pulses may e.g. be modified in response to a motion characteristic of a moving video object in the frames. For example, if it is detected that the frame contains an image that moves at a very high speed, the backlight controller 111 may proceed to select a pulse sequence with a relatively large number of pulses in order to facilitate the compensation for the perceived motion blur. However, if it is detected that the current frame comprises virtually no moving objects, the backlight controller 111 may proceed to apply a pulse sequence that e.g. only comprises two pulses (or may even switch the pulsing off).

Also, it will be appreciated that the sequence of light pulses may e.g. be modified in response to an image characteristic of the frame. For example, the total brightness of the scene may be determined and used to calculate a required backlight level. Thus, a minimum duty cycle for the backlight may be calculated and used to select the light pulse sequence. For example, the backlight controller 111 may proceed to select a nominal pulse sequence suitable for effective motion blur compensation by pre-filtering. This nominal pulse sequence may be optimized for motion blur compensation but may accordingly have a relatively low duty cycle (say around 50%). This may provide improved performance for most frames but may be insufficient for a very bright image. Therefore, if it is detected that the image of the current frame is so bright that it requires a higher duty cycle, the backlight controller 111 may instead select a different pulse sequence (say one having a duty cycle of 80%). This may allow the brightness of the scene to be generated but may result in less efficient motion blur compensation. The backlight controller 111 may communicate to the motion blur processor 113 which sequence is selected for the individual frame and the appropriate motion blur compensation filter may accordingly be applied. Similarly, the compensation processor 107 may also be arranged to adjust the pixel values for the variations in the duty cycle (i.e. for the variation in the backlight intensity). Thus, the approach may allow a dynamic trade-off between brightness and motion blur compensation.

It will be appreciated that whereas the previous description focused on embodiments wherein the display was a backlight display, the principles are equally appropriate to hold type displays that do not utilize a backlight. For example, in an OLED display, the pulsing may be implemented by directly pulsing the light radiated by the individual pixels.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A display control apparatus, comprising:
means (105) for providing a video signal comprising frames;
means (109) for presenting the video signal on a display (103);
control means (111) for controlling the display (103) to radiate light in a sequence of light pulses for each frame, the sequence of light pulses comprising light pulses having different durations;
determining means (113) for determining a first filter corresponding to an inverse filter of the sequence of light pulses; and
filter means (107) for filtering at least part of a first frame in response to the first filter.

2. The display control apparatus of claim 1 wherein
the determining means (113) is arranged to
determine a spatial filter corresponding to a filtering effect of the sequence of light pulses applied to a moving object in the first frame; and
determine the first filter as corresponding to an inverse of the spatial filter; and
the filtering means (107) is arranged to apply the first filter to the moving object in the first frame.

3. The display control apparatus of claim 2 wherein the determining means (113) is arranged to determine the spatial filter as having a spatial impulse response corresponding to a motion of the moving object during the light pulses of the sequence of light impulses.

4. The display control apparatus of claim 2 wherein the determining means (113) is arranged to determine an amplitude frequency response of the spatial filter and to determine an amplitude frequency response of the first filter in response to a reciprocal of the amplitude frequency response of the spatial filter.

5. The display control apparatus of claim 1 wherein the sequence of light pulses comprises at least four light pulses having different durations.

6. The display control apparatus of claim 1 wherein durations of at least two light pulses of the sequence of light pulses differ by at least 10% of the frame rate.

7. The display control apparatus of claim 1 wherein the sequence of light pulses is such that a total duration of light radiation during a frame duration is between 20% and 80% of the frame duration.

8. The display control apparatus of claim 1 wherein a frequency response of an impulse response corresponding to the sequence of light pulses has a dynamic range of less than 10 dB in at least 95% of a frequency range from 0 Hz to 100 Hz.

9. The display control apparatus of claim 1 wherein the control means (111) is arranged to control a backlight for the display (103) in response to the sequence of light pulses.

10. The display control apparatus of claim 1 wherein a repeated pattern of light pulses is synchronized with a line time for the display (103).

11. The display control apparatus of claim 1 wherein a repeated pattern of light pulses is synchronized with a frame time for the display (103).

12. The display control apparatus of claim 1 wherein the control means (111) is arranged to modify the sequence of light pulses in response to motion characteristics of a moving video object in the frames.

13. The display control apparatus of claim 1 wherein the control means (111) is arranged to modify the sequence of light pulses in response to an image characteristic of a frame.

14. The display control apparatus of claim 1 wherein the control means (111) is arranged to uniformly apply the sequence of light pulses to a full display area of the display (103).

15. A method of controlling a display (103), the method comprising:
providing a video signal comprising frames;
presenting the video signal on a display (103);
controlling the hold-type display to radiate light in a sequence of light pulses for each frame, the sequence of light impulses comprising light pulses having different durations;
determining a first filter corresponding to an inverse filter of the sequence of light impulses; and
filtering at least part of a first frame in response to the first filter.
